(19) United States
(12) Patent Application Publication
(10) Pub. No.: US 2011/0069242 A1
(43) Pub. Date: Mar. 24, 2011

(54) PROJECTION DESPLAY APPARATUS

(75) Inventors: Ken MASHITANI, Hirakata-City (JP); Takashi IKEDA, Osaka-City (JP); So SUZUKI, Osaka-City (JP); Hiroaki YOSHIDA, Takatsuki-City (JP); Kiyoko TSUJI, Daito-City (JP); Michihiro OKUDA, Hirakata-City (JP); Ippei OHASHI, Osaka (JP); Takehiko TAKIMOTO, Kakogawa-City (JP); Yasuhide KOGO, Amagasaki-City (JP)

(73) Assignee: SANYO ELECTRIC CO., LTD., Moriguchi City (JP)

(21) Appl. No.: 12/892,140

(22) Filed: Sep. 28, 2010

Related U.S. Application Data
(63) Continuation of application No. PCT/JP2009/056077, filed on Mar. 26, 2009.

(30) Foreign Application Priority Data
Mar. 28, 2008 (JP) 2008-088347
Mar. 19, 2009 (JP) 2009-068944

(51) Int. Cl. G02F 1/1335; G03B 21/28

(52) U.S. Cl. 349/5; 353/98

(57) ABSTRACT

A projection display apparatus (100) has an image light generating unit (200), a projection optical unit (300) and a screen (220). The projection optical unit (300) has a reflection mirror (320). The screen (220) is switchably configured to as to switch to whether to diffuse image light reflected by the reflection mirror (320) or to transmit the image light reflected by the reflection mirror (320).

### CROSS-REFERENCES TO RELATED APPLICATIONS

This application is a continuing application according to 37 C.F.R. 1.53(b) and (j) of the international application number PCT/JP2009/056077 filed on Mar. 26, 2009, which in turn claims the benefit of Japanese patent application number 2008-088347, filed on Mar. 28, 2008 and Japanese application number 2009-068944, filed on Mar. 19, 2009, the disclosures of which applications are incorporated by reference herein.

### TECHNICAL FIELD

The present invention relates to a projection display apparatus having a projection optical unit for projecting image light on a projection plane.

### BACKGROUND ART

Conventionally, there has been known a projection display apparatus having: a light valve for modulating light emitted from a light source; and a projection lens for projecting the light emitted from the light valve on a projection plane (screen).

Hence, a long distance between the projection lens and the screen needs to be assured for displaying a large-size image on the screen. In contrast to this, a projection display system has been proposed which aims to shorten a distance between the projection display apparatus and the screen by using a reflection mirror for reflecting the light emitted from the projection lens, toward the screen side (for example, Japanese Patent Application Publication No. 2006-235516).

With the aim of shortening a distance between the projection display apparatus and the screen, the projection display apparatus becomes in proximity to the screen, and the projection display apparatus becomes within a user's field of view. Thus, there is a need to perform vertically or laterally oblique projection of the screen. For example, in the above-described projection display system, a projection distance is shortened and oblique projection is performed by shifting a positional relationship between a light valve and a projection optical unit in a vertical direction and employing a concave mirror as a reflection mirror.

Incidentally, as a method of setting up a projection display apparatus which aims to shorten a projection distance, there is considered a new setup method, such as a method of setting up a projection display apparatus on a wall surface or the like, since the device is capable of projecting an image even in a small space, or alternatively, a method of setting up a projection display apparatus on a ceiling or a floor surface. On the other hand, a screen provided on a projection plane is not considered so much.

### DISCLOSURE OF THE INVENTION

A first aspect of a projection display apparatus, includes: an image light generating unit (image light generating unit 200) configured to generate image light; and a projection optical unit (projection optical unit 300) configured to project the image light on a projection plane (projection plane 210). The projection optical unit has a reflection mirror (reflection mirror 320) configured to reflect the image light emitted from the image light generating unit. The projection display apparatus further includes a screen (screen 220) provided on the projection plane. The screen is switchably configured as to whether to diffuse the image light reflected by the reflection mirror or to transmit the image light reflected by the reflection mirror.

According to the above aspect, the screen is switchably configured as to whether or not the image light reflected by the reflection mirror forms an image. Therefore, the display/non-display of an image can be readily switched.

In the first aspect, the screen comprised of a dispersive liquid crystal. The dispersive liquid crystal adjusts a diffusion ratio of the image light reflected by the reflection mirror, in accordance with a voltage applied to the dispersive liquid crystal.

In the first aspect, the screen has an image forming region (image forming region 220a) in which an image is comprised of the image light, and a non-image forming region (non-image forming region 220b) in which an image is not comprised of the image light. The screen is configured to be slidable on the projection plane. The non-image forming region is comprised of a light-transmissive member and is adjacent to the image forming region in a sliding direction of the screen.

In the first aspect, the projection display apparatus further includes a protection cover (protection cover 400 provided on an optical path of the image light reflected by the reflection mirror. The protection cover has a transmissive region (transmissive region 410) for transmitting the image light. The reflection mirror focuses the image light emitted from the image light generating unit, between the reflection mirror and the projection plane. The transmissive region is disposed in proximity to a position at which the image light is focused by the reflection mirror.

In the first aspect, the protection cover has an opening communicating from a side of the reflection mirror to a side of the projection plane. The transmissive region is the opening.

In the first aspect, at least part of the protection cover is comprised of a light-transmissive member. The transmissive region is comprised of the light-transmissive member.

In the first aspect, the screen includes a first screen and a second screen. A respective one of the first screen and the second screen is switchably configured as to whether to diffuse the image light reflected by the reflection mirror or to transmit the image light reflected by the reflection mirror.

In the first aspect, the screen is comprised of a plurality of regions. The screen is switchably configured, in a respective one of the plurality of regions as to whether to diffuse the image light reflected by the reflection mirror or to transmit the image light reflected by the reflection mirror.

### BRIEF DESCRIPTION OF THE DRAWINGS

FIG. 1 is a view showing a projection display apparatus 100 according to a first embodiment.

FIG. 2 is a view showing a configuration of an image light generating unit 200 according to the first embodiment.

FIG. 3 is a view showing a configuration of a screen 220 according to the first embodiment.

FIG. 4 is a view showing the configuration of the screen 220 according to the first embodiment.

FIG. 5 is a view showing a display example according to the first embodiment.

FIG. 6 is a view showing the display example according to the first embodiment.

FIG. 7 is a view showing the display example according to the first embodiment.

FIG. 8 is a view showing the display example according to the first embodiment.

FIG. 9 is a view showing a configuration of a screen 220 according to a second embodiment.

FIG. 10 is a view showing sliding of the screen 220 according to the second embodiment.

FIG. 11 is a view showing sliding of the screen 220 according to the second embodiment.

FIG. 12(A) and FIG. 12(B) are views showing examples of application of a projection display apparatus 100 according to a third embodiment.

FIG. 13(A) to FIG. 13(C) are views showing examples of application of the projection display apparatus 100 according to the third embodiment.

FIG. 14 is a view showing a screen 500 according to a fourth embodiment.

FIG. 15 is a view showing the screen 500 according to the fourth embodiment.

FIG. 16 is a view showing the screen 500 according to the fourth embodiment.

FIG. 17 is a view showing the screen 500 according to the fourth embodiment.

FIG. 18 is a further view showing the screen 500 according to the fourth embodiment.

FIG. 19 is a view showing a display example according to the fourth embodiment.

FIG. 20 is a view showing the display example according to the fourth embodiment.

FIG. 21 is a view showing the display example according to the fourth embodiment.

FIG. 22 is a view showing the display example according to the fourth embodiment.

FIG. 23 is a view showing the display example according to the fourth embodiment.

FIG. 24 is a view showing the display example according to the fourth embodiment.

FIG. 25 is a view showing a screen 600 according to a fifth embodiment.

FIG. 26 is a view showing the screen 600 according to a sixth embodiment.

FIG. 27 is a view showing a display example according to the sixth embodiment.

FIG. 28 is a view showing the display example according to the sixth embodiment.

FIG. 29 is a view showing the display example according to the sixth embodiment.

FIG. 30 is a view showing the display example according to the sixth embodiment.

FIG. 31 is a view showing the display example according to the sixth embodiment.

### BEST MODE FOR CARRYING OUT THE INVENTION

Hereinafter, a projection display apparatus according to embodiments of the present invention will be described with reference to the drawings. In the following description of the drawings, the same or similar reference signs are attached to the same or similar units and portions.

It should be noted that the drawings are schematic and ratios of dimensions and the like are different from actual ones. Therefore, specific dimensions and the like should be determined in consideration of the following description. Moreover, as a matter of course, the drawings also include portions having different dimensional relationships and ratios from each other.

### First Embodiment

### Configuration of Projection Display Apparatus

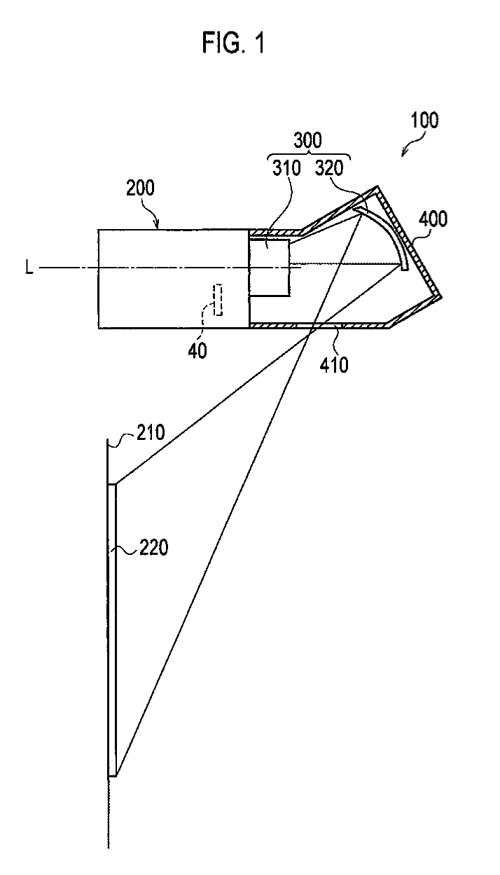

Hereinafter, a configuration of a projection display apparatus according to a first embodiment will be described with reference to the drawings. FIG. 1 is a view showing a configuration of a projection display apparatus 100 according to the first embodiment.

As shown in FIG. 1, the projection display apparatus 100 has an image light generating unit 200, a projection optical unit 300, a protection cover 400, and a screen 220.

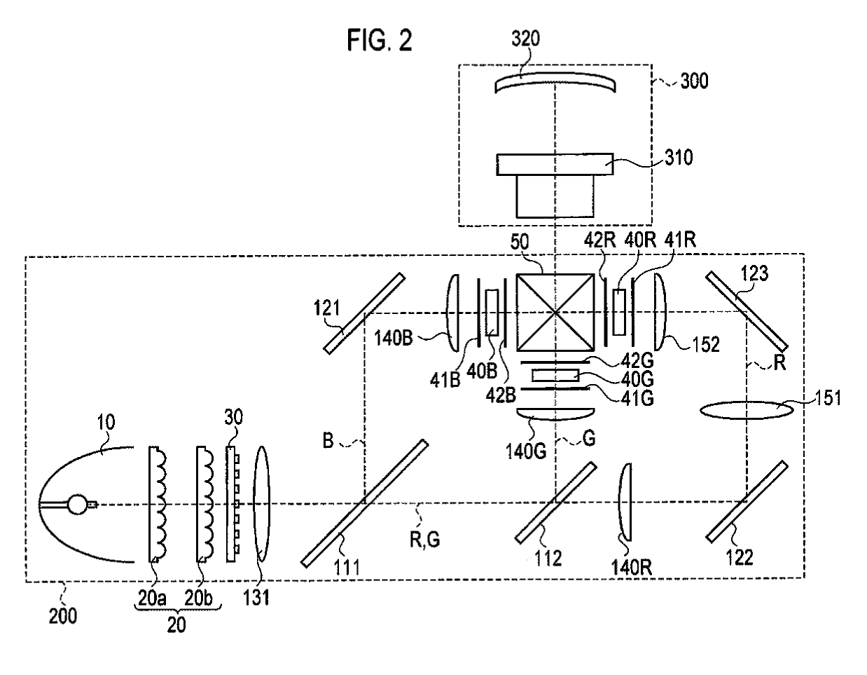

The image light generating unit 200 generates image light. Specifically, the image light generating unit 200 has at least a display element 40 for emitting image light. The display element 40 is provided at a position which is shifted relative to an optical axis L of the projection optical unit 300. The display element 40 is a reflective liquid crystal panel, a transmissive liquid crystal panel, a DMD (Digital Micromirror Device) or the like, for example. A detailed description of the image light generating unit 200 will be given later (see FIG. 2).

The projection optical unit 300 projects the image light emitted from the image light generating unit 200. Here, the projection optical unit 300 projects the image light on a projection plane 210 (screen 220). Specifically, the projection optical unit 300 has a projection lens 310 and a reflection mirror 320.

The projection lens 310 emits the image light emitted from the image light generating unit 200, to the side of the reflection mirror 320.

The reflection mirror 320 reflects the image light emitted from the projection lens 310. The reflection mirror 320 widely angles the image light after focusing the image light. The reflection mirror 320 is a non-spherical mirror having a concave face on the side of the image light generating unit 200, for example.

The protection cover 400 is a cover for protecting the reflection mirror 320. The protection cover 400 is provided on an optical path of the image light reflected by the reflection mirror 320. The protection cover 400 has a transmissive region 410 for transmitting image light. That is, the transmissive region 410 transmits the image light reflected by the reflection mirror 320 to the side of the screen 220.

In this manner, the projection optical unit 200 projects the image light transmitting the transmissive region 410 on the screen 220 provided on the projection plane 210.

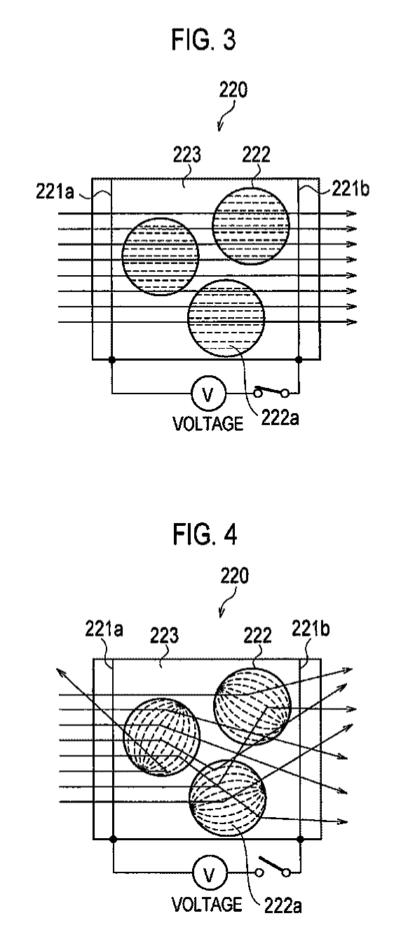

The screen 220 is provided on the projection plane 210 on which image light is to be projected. The screen 220 is switchably configured as to whether to diffuse the image light reflected by the reflection mirror 320 or transmit the image light reflected by the reflection mirror 320. In other words, the screen 220 is switchably configured as to whether or not an image is formed by the image light reflected by the reflection mirror 320. The screen 220 is a screen comprised of a dispersive liquid crystal, for example. The dispersive liquid crystal, as described later, adjusts a diffusion ratio of the image light reflected by the reflection mirror 320, in accordance with a voltage to be applied to the dispersive liquid crystal (see FIG. 3 and FIG. 4).

It is preferable that the screen 220 is transparent. In addition, the screen 220 may be a reflective screen or may be a transmissive screen.

(Configuration of Image Light Generating Unit)

Hereinafter, a configuration of an image light generating unit according to the first embodiment will be described with reference to the drawings. FIG. 2 is a view mainly showing an image light generating unit 200 according to the first embodiment. The image light generating unit 200 has a power circuit (not shown) and an image signal processing circuit (not shown) or the like in addition to the constituent elements shown in FIG. 2. Here is illustrated a case in which a display element 40 is a transmissive liquid crystal panel.

The image light generating unit 200 has a light source 10, a fly-eye lens unit 20, a Polarizing Beam Splitter (PBS) array 30, a plurality of liquid crystal panels 40 (liquid crystal panel 40R, liquid crystal panel 40G, liquid crystal panel 40B), and a crass-dichroic prism 50.

The light source 10 is a UHP lamp or the like comprised of a burner and a reflector. The light emitted from the light source 10 includes red component light, green component light, and blue component light.

The fly-eye lens unit 20 uniformizes the light emitted from the light source 10. Specifically, the fly-eye lens unit 20 is comprised of a fly-eye lens 20a and a fly-eye lens 20b.

The fly-eye lens 20a and the fly-eye lens 20b are comprised of a plurality of micro-lenses, respectively. Each micro-lens focuses the light emitted from the light source 10 so that the light emitted from the light source is irradiated to all over the liquid crystal panel 40.

The PBS array 30 coordinates a polarization state of the light emitted from the fly-eye lens unit 20. In the first embodiment, the PBS array 30 coordinates the light emitted from the fly-eye lens 20 with P-polarization.

The liquid crystal panel 40R modulates red component light by rotating the polarization direction of the red component light. An incidence-side polarization plate 41R, for transmitting the light having one polarization direction (for example, P-polarization) and interrupting the light having the other polarization direction (for example, S-polarization), is provided on the light-incidence plane side of the liquid crystal panel 40R. An emission-side polarization plate 42R, for interrupting the light having one polarization direction (for example, P-polarization) and transmitting the light having the other polarization direction (for example, S-polarization), is provided on the light-emission plane side of the liquid crystal panel 40R.

Similarly, the liquid crystal panel 40G and the liquid crystal panel 40B modulate green component light and blue component light by rotating the polarization direction of the green component light and the blue component light, respectively. The incidence-side polarization plate 41G is provided on the light-incidence plate side of the liquid crystal panel 400 and an emission-side polarization plate 42G is provided on the light-emission plane side of the liquid crystal panel 40G. An incidence-side polarization plate 41B is provided on the light-incidence plane side of the liquid crystal panel 40B and an emission-side polarization plate 42B is provided on the light-emission plane side of the liquid crystal panel 40B.

The cross-dichroic prism 50 combines the light emitted from the liquid crystal panel 40R, the liquid crystal panel 40G, and the liquid crystal panel 40B with each other. The cross-dichroic prism 50 emits the combined light to the side of the projection lens 310.

In addition, the image light generating unit 200 has: a mirror group (dichroic mirror 111, dichroic mirror 112, reflection mirror 121 to reflection mirror 123); and a lens group (condenser lens 131, condenser lens 140R, condenser lens 1400, condenser lens 140B, relay lens 151 and relay lens 152).

The dichroic mirror 111 transmits red component light and green component light of the light emitted from the PBS array 30. The dichroic mirror 111 reflects blue component light of the light emitted from the PBS array 30.

The dichroic mirror 112 transmits red component light of the light transmitting the dichroic mirror 111. The dichroic mirror 112 reflects green component light of the light transmitting the dichroic mirror 111.

The reflection mirror 112 reflects blue component light and guides the reflected light to the side of the liquid crystal panel 4013. The reflection mirror 122 and the reflection mirror 123 reflect red component light and guide the reflected light to the side of the liquid crystal panel 40R.

The condenser lens 131 is a lens for focusing incandescent light emitted from the light source 10.

The condenser lens 140R substantially collimates red component light so that the liquid crystal panel 40R is irradiated with the red component light. The condenser lens 140G substantially collimates green component light so that the liquid crystal panel 40G is irradiated with the green component light. The condenser lens 140B substantially collimates blue component light so that the liquid crystal panel 40B is irradiated with the blue component light.

The relay lens 151 and the relay lens 152 substantially form an image with the red component light on the liquid crystal panel 40R while restraining expansion of the red component light.

(Configuration of Dispersive Liquid Crystal)

Hereinafter, a dispersive liquid crystal configuring the screen 220, according to the first embodiment, will be described with reference to the drawings. FIG. 3 and FIG. 4 are views showing the dispersive liquid crystal configuring the screen 220, according to the first embodiment. Here is illustrated a case in which the screen 220 is a transmissive screen.

As shown in FIG. 3 and FIG. 4, the dispersive liquid crystal configuring the screen 220 has a transparent conductive film 221 (transparent conductive film 221a and transparent conductive film 221b); a liquid crystal capsule 222 having a plurality of liquid crystal elements 222a; and a polymer 223.

The transparent conductive film 221 is a transparent film having conductivity. Indium Tin Oxide (ITO) can be employed as the transparent conductive film 221, for example.

The liquid crystal capsule 222 is comprised of the plurality of liquid crystal elements 222a. As the liquid crystal element 222a, for example, a nematic liquid crystal or a cholesteric liquid crystal can be employed. The liquid crystal capsule 222 disperses in the polymer 223.

The polymer 223 is comprised of a high polymer. As the high polymer, polymethyl methacrylate (PMMA) can be employed, for example. The polymer 223 is filled between the transparent conductive film 221a and the transparent conductive film 221b.

Here, as shown in FIG. 3, in a case where a voltage is applied to the transparent conductive film 221, the liquid crystal element 222a included in the liquid crystal capsule 222 is uniform in its orientation direction. Therefore, the light with which the screen 220 is irradiated transmits a dispersive liquid crystal. That is, the screen 220 disallows an image to be comprised of the image light reflected by the reflection mirror 320.

On the other hand, as shown in FIG. 4, in a case where a voltage is not applied to the transparent conductive film 221, the liquid crystal element 222a included in the liquid crystal capsule 222 is not uniform in its orientation direction. Therefore, the light with which the screen 220 is irradiated diffuses. That is, the screen 220 allows an image to be comprised of the image light reflected by the reflection mirror 320.

It is preferable that a ratio (transmission/diffusion ratio) of a dispersive liquid crystal diffusing image light is adjustable in accordance with a voltage applied to the transparent conductive film 221. In addition, in a case in which the screen 220 is a reflective screen as well, it is also preferable that a ratio (reflection/diffusion ratio) of the dispersive liquid crystal diffusing image light is adjustable in accordance with the voltage applied to the transparent conductive film 221.

Here, from the viewpoint of energy saving or the like, it is preferable that the screen 220 is configured in a state in which image light is diffused in a case where no voltage is applied. In this manner, in a case where the projection display apparatus 100 is not powered on, a voltage does not need to be applied to the screen 220, disabling an object or the like provided on the rear side of the screen 220 to be seen by default.

In addition, from the viewpoint of energy saving or the like, in a case where the screen 220 is controlled in a state in which image light is transmitted, it is preferable that the projection display apparatus 100 is powered off. In a case where the screen 220 is controlled in a state in which image light is transmitted, there is no need for the image light from the projection display apparatus 100, thus enabling energy saving to be achieved by turning off the power of the projection display apparatus 100.

(Image Display Example(s))

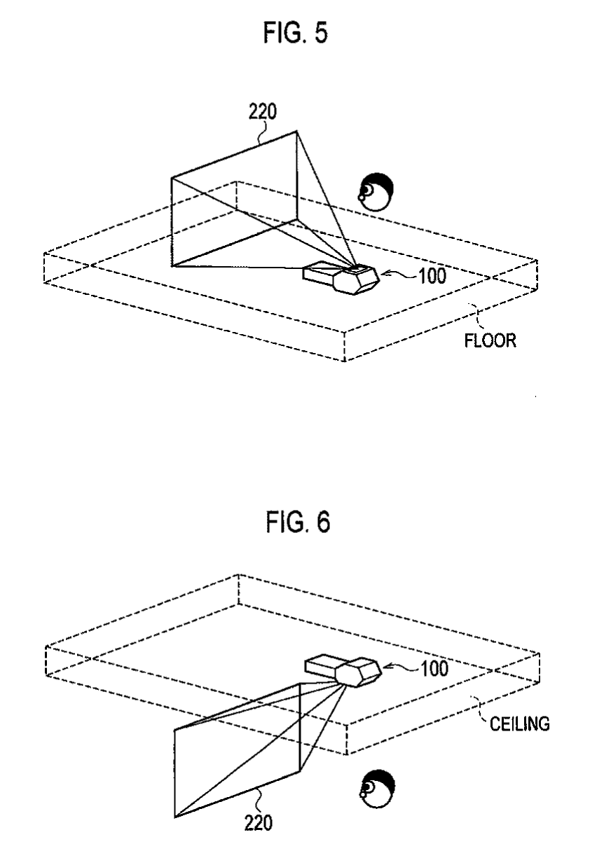

Hereinafter, image display examples according to the first embodiment will be described with reference to the drawings. FIG. 5 to FIG. 8 are views showing image display examples according to the first embodiment. Hereinafter is illustrated a case in which the screen 220 is a transparent.

First, a case in which the screen 220 is provided on a wall surface will be described with reference to FIG. 5 and FIG. 6. FIG. 5 and FIG. 6 each illustrate a case in which the screen 220 is a reflective screen.

As shown in FIG. 5, the projection display apparatus 100 is embedded in a floor and the screen 220 is provided on a transparent wall surface (projection plane 210). On the other hand, as shown in FIG. 6, the projection display apparatus 100 is embedded in ceiling and the screen 220 is provided on a transparent wall surface (projection plane 210). In these cases, the projection display apparatus 100 projects image light on the screen 220 provided on the transparent wall surface (projection plane 210).

As described above, in a case where no voltage is applied to the screen 220, the image light emitted from the projection display apparatus 100 forms an image on the screen 220. Therefore, a user can see the image formed on the screen 220.

On the other hand, in a case where a voltage is applied to the screen 220, the image light emitted from the projection display apparatus 100 does not form an image on the screen 220. Here, in a case where the voltage is applied to the screen 220, it is preferable that the projection display apparatus 100 provides black display. That is, no image light is emitted from the projection display apparatus 100. As described above, since the screen 220 is transparent, a user can see an opposite scene of the screen 220 from the user's field of view.

In “black display”, for example, a polarization plate provided at the light incidence-side or light emission-side of the display element 40 interrupts the light emitted from a light source 10. That is, it should be kept in mind that the light source 10 does not need to migrate to a non-illuminative state. In the “black display”, the light source 10 may migrate to the non-illuminative state”.

As the cases shown in FIG. 5 and FIG. 6, it is considered that the screen 200 is provided at a display window. In this manner, the contents of the display window and an image can be switched from each other as an object to be shown to a user. In addition, it is considered that the screen 220 is provided at a window. In this manner, the scene outside of the window and an image can be switched from each other as an object to be shown to a user.

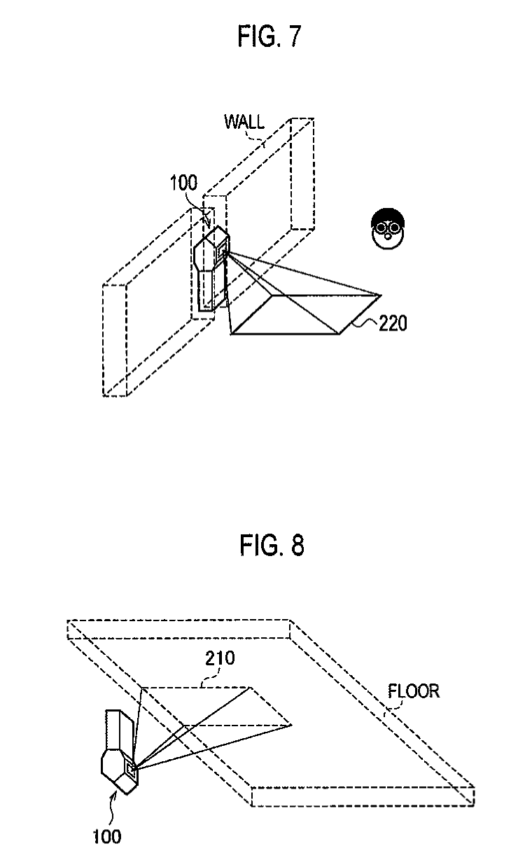

Next, a case in which the screen 220 is provided on a floor surface will be described with reference to FIG. 7 and FIG. 8. FIG. 7 illustrates a case in which the screen 220 is a reflective screen. FIG. 8 illustrates a case in which the screen 220 is a transparent screen.

As shown in FIG. 7, the projection display apparatus 100 is embedded in a wall, and the screen 220 is provided on a floor surface (projection plane 210). On the other hand, as shown in FIG. 8, the projection display apparatus 100 is embedded beneath a floor, and the screen 220 is provided on a floor surface (projection plane 210). In these cases, the projection display apparatus 100 projects image light on the screen 220 provided on the floor surface (projection plane 210).

As described above, in a case where no voltage is applied to the screen 220, the image light emitted from the projection display apparatus 100 forms an image on the screen 220. Therefore, a user can see the image formed on the screen 220.

On the other hand, in a case where a voltage is applied to the screen 220, the image light emitted from the projection display apparatus 100 does not form an image on the screen 220. Here, in a case where a voltage is applied to the screen 220, it is preferable that the projection display apparatus 100 provides black display. That is, no image light is emitted from the projection display apparatus 100. As described above, since the screen 220 is transparent, a user can see an opposite scene of the screen 220 from the user's field of view.

As the cases shown in FIG. 7 and FIG. 8, it is considered that an ornamental object, an appreciative object or the like is provided beneath a floor. In this manner, the ornamental object, the appreciative object or the like and its related image can be switched from each other as an object to be shown to a user. Here, since the screen 220 is provided on a floor surface, it is preferable that a reinforce glass is provided on the screen 220. That is, it is preferable to protect the screen 220 by means of the reinforce glass.

In the case shown in FIG. 8, it should be kept in mind that even where a voltage is applied to the screen 220, the projection display apparatus 100 is hardly within the user's field of view, since the projection display apparatus 100 performs oblique projection.

(Function(s) and Advantageous Effect(s))

In the first embodiment, the protection cover 400 is provided on an optical path of the image light that is reflected by the reflection mirror 320. Therefore, an angle or the like of the reflection mirror 320 can be restrained from being varied by a user touching the reflection mirror 320. In addition, the protection cover 400 has a transmissive region 410 for transmitting the image light reflected by the reflection mirror 320. Therefore, the image light emitted on the screen 220 provided on the projection plane 210 is never interrupted by the protection cover 400. In this manner, the disposition precision of the reflection mirror 320 provided to shorten a distance between the projection display apparatus 100 and the screen 220 can be appropriately maintained.

In the first embodiment, the screen 220 is switchably configured as to whether or not the image light reflected by the reflection mirror 320 forms an image. Therefore, the display/non-display of an image can be readily switched.

In addition, in a case where the screen 220 is not illuminated with the image light reflected by the reflection mirror 320, where the screen 220 is transparent, the opposite scene of the screen 220 from the user's field of view and an image can be switched as an object to be shown to a user.

### Second Embodiment

Hereinafter, a second embodiment will be described with reference to the drawings. Hereinafter, differences between the first embodiment and the second embodiment will be mainly described.

In the first embodiment, the screen 220 is comprised of a dispersive liquid crystal. On the other hand, in the second embodiment, the screen 220 has an image forming region and a non-image forming region, and is configured to be slidable on the projection plane 210.

(Screen Configuration)

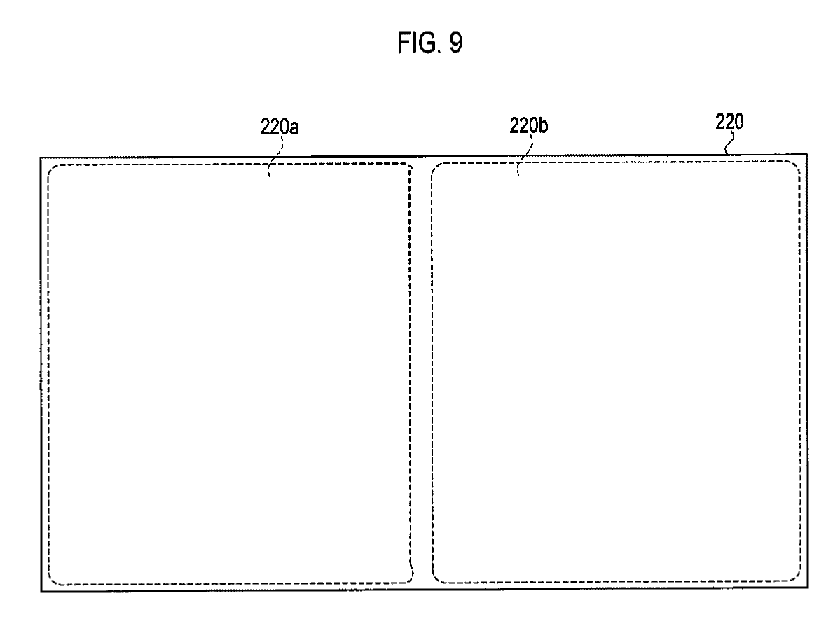

Hereinafter, a configuration of a screen according to the second embodiment will be described with reference to the drawings. FIG. 9 is a view showing the screen 220 according to the second embodiment. As shown in FIG. 9, the screen 220 has an image forming region 220a and a non-image forming region 220b.

The image forming region 220a is a region in which the image light reflected by the reflection mirror 320 forms an image. The image forming region 220a has a configuration which is similar to that of a reflective screen or a transmissive screen.

The non-image forming region 220b is a region in which the image light reflected by the reflection mirror 320 does not form an image. The non-image forming region 220b is adjacent to the image forming region 220a in a sliding direction of the screen 220. The non-image forming region 220b is comprised of a light-transmissive member.

It is preferable that the non-image forming region 220b has its shape and size which are substantially similar to those of the image forming region 220a.

(Screen Sliding)

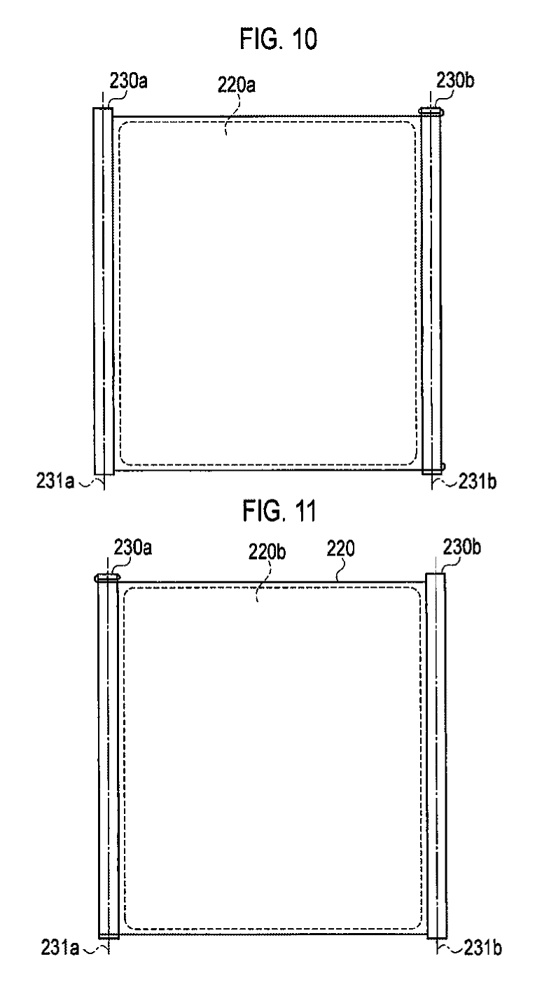

Hereinafter, sliding of the screen according to the second embodiment will be described with reference to the drawings. FIG. 10 and FIG. 11 are views showing sliding of the screen 220 according to the second embodiment.

As shown in FIG. 10 and FIG. 11, the screen 220 is mounted to a winding mechanism 230 (winding mechanism 230a and winding mechanism 230b).

The winding mechanism 230a and the winding mechanism 230b have a mechanism of winding the screen 220. Similarly, the winding mechanism 230a and the winding mechanism 230b have a mechanism of feeding out the screen 220. For example, the winding mechanism 230a and the winding mechanism 230b are turnably configured around a rotary shaft 231a and a rotary shaft 231b, respectively.

As shown in FIG. 10, in a case where the image forming region 220a is employed as the projection plane 210, the non-image forming region 220b is wound on the side of the winding mechanism 230b. On the other hand, as shown in FIG. 11, in a case where the non image forming region 220b is employed as the projection plane 210, the image forming region 220a is wound on the side of the winding mechanism 230a.

In this manner, the screen 220 is configured to be slidable on the projection plane 210 by means of the winding mechanism 230.

As a matter of course, a method of sliding the screen 220 is not limitative to winding of the screen 220.

(Function(s) and Advantageous Effect(s))

In the second embodiment, the screen 220 is configured to be slidable on the projection plane 210. Therefore, a configuration, which is capable of switching whether or not the image light emitted from the projection display apparatus 100 forms an image even without a need to employ a screen comprised of a dispersive liquid crystal, can be achieved with ease and at a low cost.

### Third Embodiment

Hereinafter, a third embodiment will be described with reference to the drawings. The third embodiment describes examples of application of the above-described projection display apparatus 100.

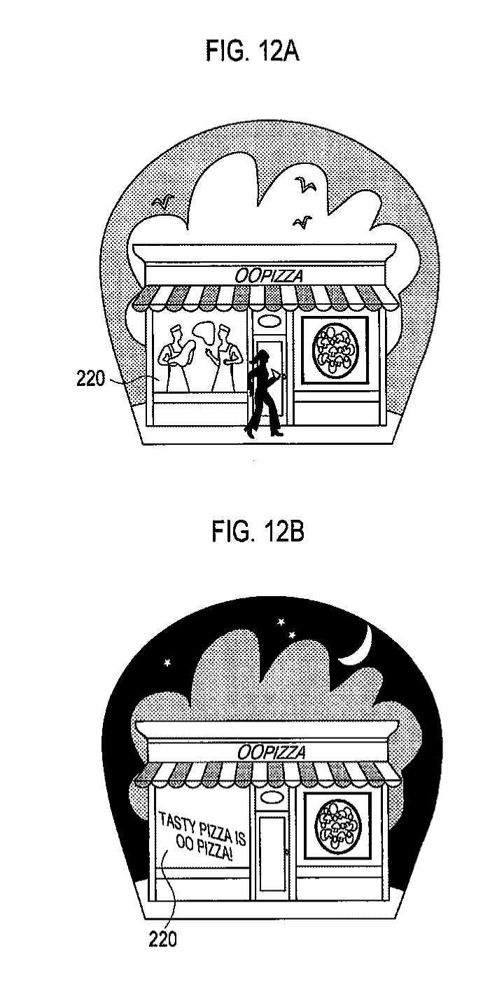

First, a case in which the screen 220 is provided at a display window's glass at a shop will be described with reference to FIG. 12(A) and FIG. 12(B). FIG. 12(A) is a view showing a shop at noon and FIG. 12(B) is a view showing a shop at night.

As shown in FIG. 12(A), at noon, an inside view of a shop is caused to be seen from the outside without forming an image on the screen 220. Alternatively, in a case where a demonstrative action such as cooking demonstration is taken, such demonstration is caused to be seen from the outside of the shop without forming an image on the screen 220.

On the other hand, as shown in FIG. 12(B), at night, an image displayed on the screen 220 is caused to be seen from the outside of the shop while the image (for example, advertisement image) is formed on the screen 220. Alternatively, after the shop has been closed, the image displayed on the screen 220 is caused to be seen from the outside of the shop while the image (for example, advertisement image) is formed on the screen 220.

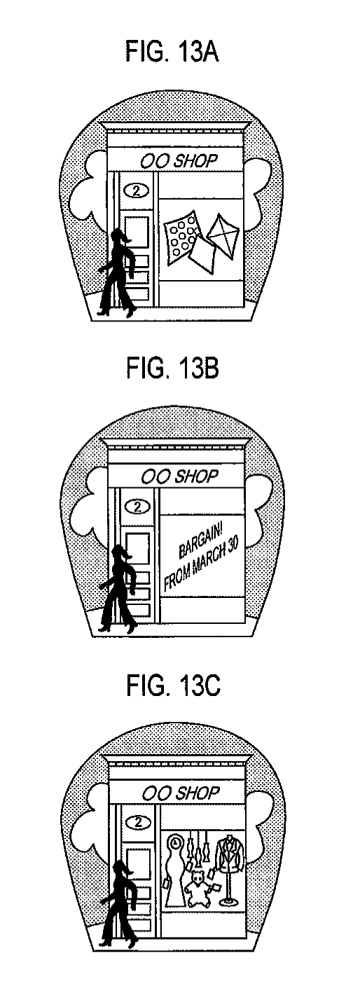

Subsequently, a case in which the screen 220 is provided at a shop's display window will be described with reference to FIG. 13(A) to FIG. 13(C). FIG. 13(A) and FIG. 13(C) are views showing a state in which commodity products are displayed in a display window and FIG. 13(B) is a view showing a state in which a layout change of commodity products is made in the display window.

As shown in FIG. 13(A) and FIG. 13(C), in a state in which commodity products are displayed in the display window, namely in a state in which a layout change of commodity products is not made, the commodity products displayed in the display window is caused to be seen from the outside of the shop without forming an image on the screen 220.

On the other hand, as shown in FIG. 13(B), in a state in which a layout change of commodity products is made in the display window, the image displayed on the screen 220 is caused to be seen from the outside of the shop while the image (for example, advertisement image) is formed on the screen 220.

### Fourth Embodiment

Hereinafter, a fourth embodiment will be described with reference to the drawings. Hereinafter, differences from the first embodiment will be mainly described.

Specifically, in the fourth embodiment, a screen includes a first screen and a second screen, and a respective one of the first and second screens is switchably configured as to whether to diffuse image light or transmit image light.

(Screen Configuration)

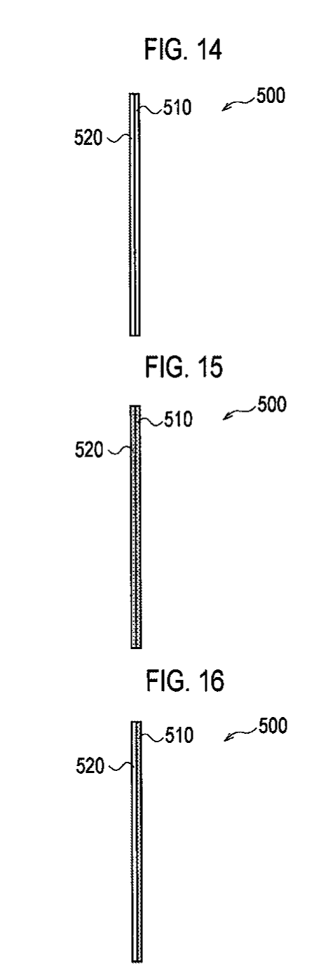

Hereinafter, a configuration of a screen according to the fourth embodiment will be described with reference to the drawings. FIG. 14 to FIG. 16 are views showing a screen 500 according to the fourth embodiment.

As shown in FIG. 14 to FIG. 16, the screen 500 includes a first screen 510 and a second screen 520. The first screen 510 and the second screen 520 are disposed in a superimposed manner.

A respective one of the first screen 510 and the second screen 520 has a configuration which is similar to that of the screen 220. For example, the respective one of the first screen 510 and the second screen 520 is comprised of a dispersive liquid crystal or the like.

Specifically, the respective one of the first screen 510 and the second screen 520 is switchably configured as to whether to diffuse the image light reflected by the reflection mirror 320 or transmit the image light reflected by the reflection mirror 320.

As shown in FIG. 14, in a case where a voltage is applied to both of the first screen 510 and the second screen 520, the first screen 510 and the second screen 520 transmit the image light reflected by the reflection mirror 320. Therefore, the first screen 510 and the second screen 520 are transparent, and no image is formed on the screen 500.

As shown in FIG. 15, in a case where a voltage is applied to neither of the first screen 510 and the second screen 520, the first screen 510 and the second screen 520 diffuse the image light reflected by the reflection mirror 320. That is, the image light reflected by the reflection mirror 320 is diffused twice. In this case, an image is formed on the screen 500.

As shown in FIG. 16, in a case where a voltage is applied to only one of the first screen 510 and the second screen 520 (herein, the first screen 510), one of the first screen 510 and the second screen 520 (herein, the first screen 510) transmits the image light reflected by the reflection mirror 320 and the other one of the first screen 510 and the second screen 520 (herein, the second screen 520) diffuses the image light reflected by the reflection mirror 320. That is, the image light reflected by the reflection mirror 320 is diffused once. In this case, an image is formed on the screen 500.

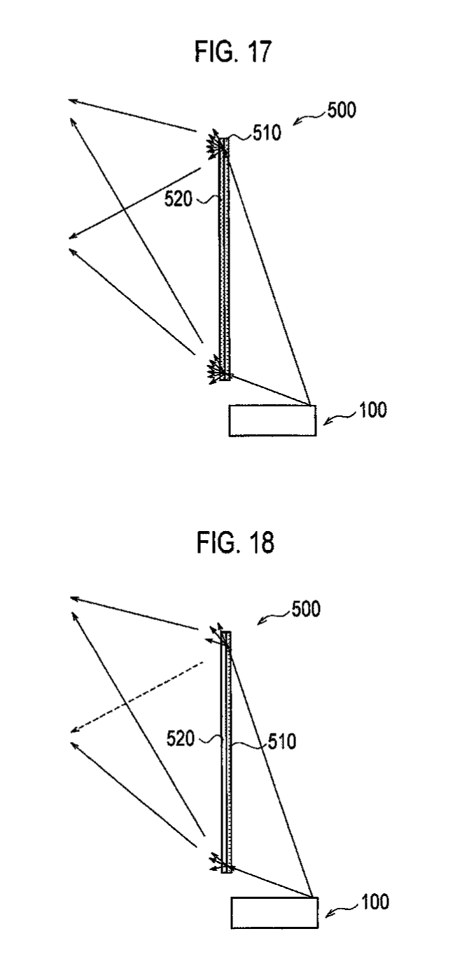

Here, as shown in FIG. 17, in a case where a voltage is applied to neither of the first screen 510 and the second screen 520, the directivity of image light is low, since the image light emitted from the projection display apparatus 100 diffuses twice. Therefore, the luminance of an image projected on the screen 500 is low, whereas a viewing angle of the image projected on the screen 500 is wide.

On the other hand, as shown in FIG. 18, in a case where a voltage is applied to only one of the first screen 510 and the second screen 520, the directivity of image light is high, since the image light emitted from the projection display apparatus 100 diffuses once. Therefore, the viewing angle of the image projected on the screen 500 is narrow, whereas the luminance of the image projected on the screen 500 is high.

In this manner, a viewing angle priority (see FIG. 17) and a luminance priority (see FIG. 18) can be switched from each other by controlling the voltage applied to the first screen 510 and the second screen 520.

(Image Display Example(s))

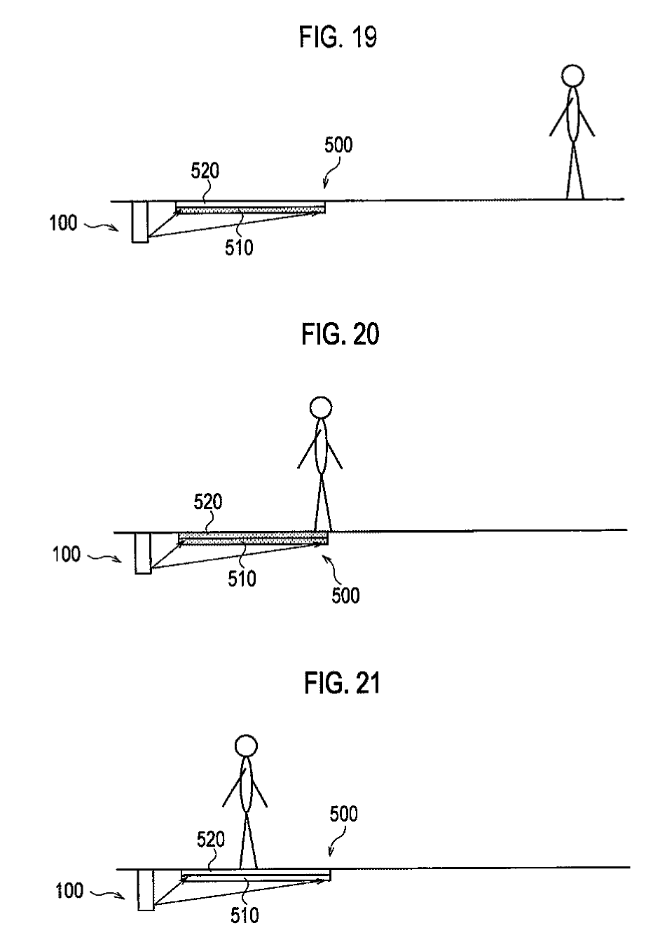

Hereinafter, image display examples according to the fourth embodiment will be described with reference to the drawings. FIG. 19 to FIG. 24 are views showing the image display examples according to the fourth embodiment

First, a case in which the projection display apparatus 100 is embedded beneath a floor and the screen 500 is provided on a floor surface will be described with reference to FIG. 19 to FIG. 21.

As shown in FIG. 19, in a case where a user takes a position remotely of the screen 500, a voltage is applied to only one of the first screen 510 and the second screen 520. Therefore, the directivity of image light is high, allowing an image to be shown to the user taking the position remotely of the screen 500. In other words, while the user takes a position remotely of the screen 500, since the luminance of the image projected on the screen 500 is high, the image can be shown to the user.

As shown in FIG. 20, in a case where a user takes a position proximal to the screen 500, a voltage is applied to neither of the first screen 510 and the second screen 520. Therefore, since the directivity of image light is low, an image can be shown to the user that takes the position proximal to the screen 500. In other words, while the luminance of the image projected on the screen 500 is low, since the user takes a position proximal to the screen 500, the image can be shown to the user.

As shown in FIG. 21, in a case where a user takes a position on the screen 500, a voltage is applied to both of the first screen 510 and the second screen 520. Therefore, the screen 500 becomes rapidly transparent, enabling provision of a user-startling effect. In addition, an object disposed under the screen 500 can be shown to a user.

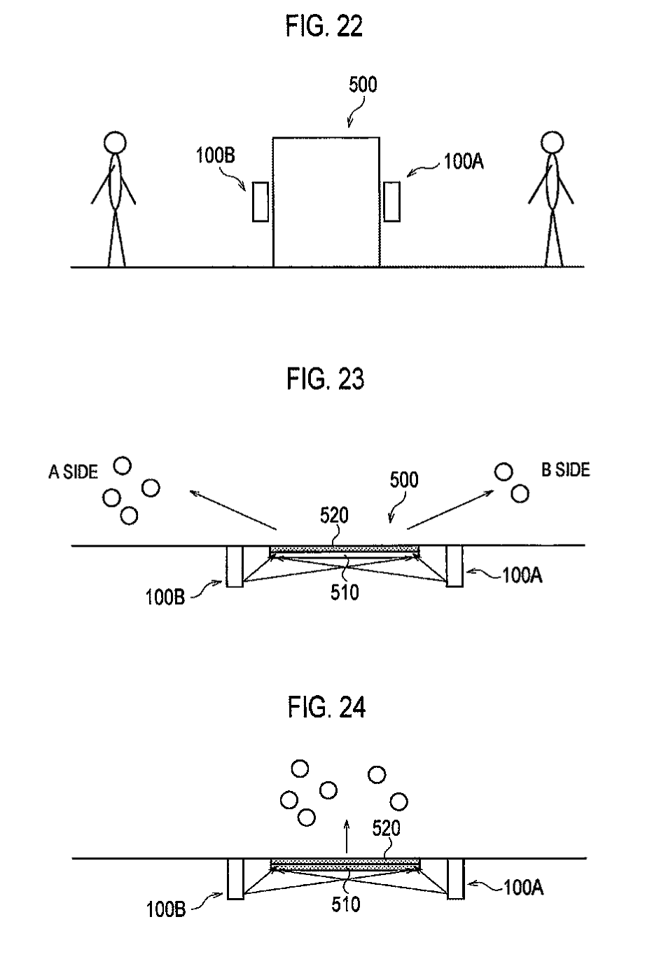

Second, a case in which the projection display apparatus 100 is embedded in a wall and the screen 500 is provided on a wall surface will be described with reference to FIG. 22 to FIG. 24.

As shown in FIG. 22, two projection display apparatuses 100 (projection display apparatus 100A and projection display apparatus 100B) are embedded in a wall while the screen 500 provided on a wall surface is sandwiched therebetween. Here, the projection display apparatus 100A and the projection display apparatus 100B display images which are similar to each other on the screen 500.

As shown in FIG. 23, in a case where a user does not take a position proximal to the screen 500, a voltage is applied to only one of the first screen 510 and the second screen 520. FIG. 23 is a top view of the projection display apparatus 100 and the screen 500. Here, since the directivity of the image light emitted from the projection display apparatus 100A is high, an image can be shown to a user taking an A-side position. Similarly, since the directivity of the image light emitted from the projection display apparatus 100B is high, an image can be shown to a user taking a B-side position.

As shown in FIG. 24, in a case where a user takes a position proximal to the screen 500, a voltage is applied to neither of the first screen 510 and the second screen 520. FIG. 24 is a top view of the projection display apparatus 100 and the screen 500. Here, since the directivity of the image light emitted from the projection display apparatus 100A and the projection display apparatus 100B is low, an image can be shown to the user taking the position proximal to the screen 500.

Although not set forth in the fourth embodiment, the user's position may be detected by means of a sensor or a camera provided on a wall surface or a floor surface.

(Function(s) and Advantageous Effect(s))

In the fourth embodiment, the screen 500 includes the first screen 510 and the second screen 520. The respective one of the first screen 510 and the second screen 520 transmits the image light reflected by the reflection mirror 320 or diffuses the image light reflected by the reflection mirror 320.

Therefore, the directivity of the image light emitted from the projection display apparatus 100 can be controlled. In addition, an image displayed on the screen 500 can be appropriately shown to a user in accordance with the user's position.

### Fifth Embodiment

Hereinafter, a fifth embodiment will be described with reference to the drawings. Hereinafter, differences from the fourth embodiment will be mainly described.

Specifically, in the fifth embodiment, a screen has a plurality of dispersive liquid crystal films sandwiched between glass plates. The glass plates and the dispersive liquid crystal films are bonded with each other by means of adhesive.

(Screen Configuration)

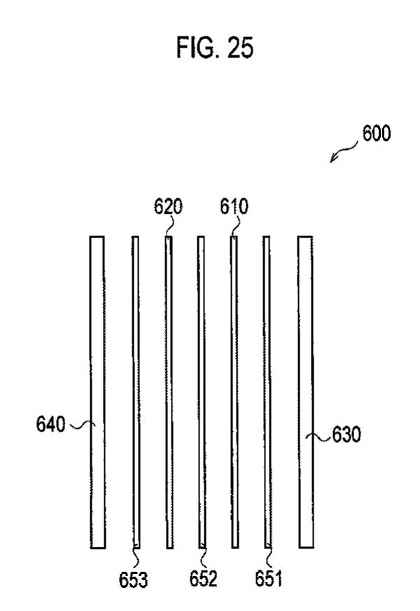

Hereinafter, a configuration of a screen according to the fifth embodiment will be described with reference to the drawings. FIG. 25 is a view showing a screen 600 according to the fifth embodiment.

As shown in FIG. 25, the screen 600 has a dispersive liquid crystal film 610, a dispersive liquid crystal film 620, a glass plate 630, and a glass plate 640. The dispersive liquid crystal film 610 and the glass plate 630 are bonded with each other by means of adhesive 651. The dispersive liquid crystal film 610 and the glass plate 620 are bonded with each other by means of adhesive 652. The dispersive liquid crystal film 620 and the glass plate 640 are bonded with each other by means of adhesive 653.

The respective one of the dispersive liquid crystal Mm 610 and the dispersive liquid crystal film 620 transmits the image light reflected by the reflection mirror 320 or diffuses the image light reflected by the reflection mirror 320. It is preferable that an interval between the dispersive liquid crystal Mm 610 and the dispersive liquid crystal Mm 620, namely, the thickness of the adhesive 652 is smaller than a pixel interval on the screen 600. For example, in a case where the size of the screen 600 is 100 inches and the pixel interval on the screen 600 is on the order of 500 microns, the interval between the dispersive liquid crystal film 610 and the dispersive liquid crystal film 620 is 20 microns.

Since the dispersive liquid crystal film 610 and the dispersive liquid crystal film 620 have a configuration which is similar to those of the first screen 510 and the second screen 520, a detailed description of the dispersive liquid crystal film 610 and the dispersive liquid crystal film 620 is omitted.

### Sixth Embodiment

Hereinafter, a sixth embodiment will be described with reference to the drawings. Hereinafter, differences from the first embodiment will be mainly described.

Specifically, in the sixth embodiment, a screen is comprised of a plurality of regions. In addition, the screen is switchably configured as to whether or not to diffuse image light or transmit image light in a respective one of a plurality of regions.

(Screen Configuration)

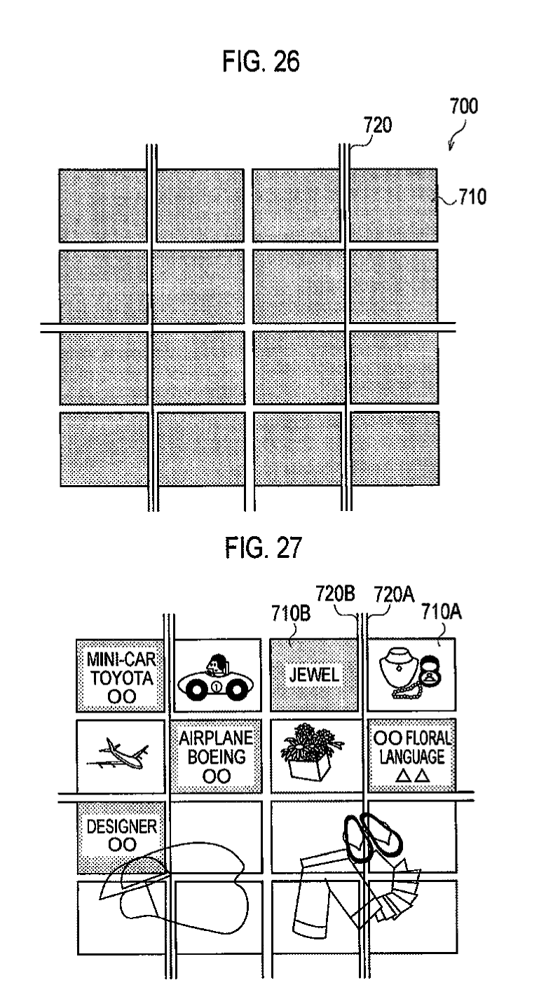

Hereinafter, a configuration of a screen according to the sixth embodiment will be described with reference to the drawings. FIG. 26 is a view showing a screen 700 according to the sixth embodiment.

As shown in FIG. 26, the screen 700 is comprised of a plurality of regions 710. An electrode 720 is connected to a respective one of the regions 710. The screen 700 is comprised of a dispersive liquid crystal, for example. The screen 700 is configured to switch whether to diffuse image light or to transmit image light in accordance with the voltage applied via a respective one of the electrodes 720 in a respective one of the regions 710.

(Image Display Example(s))

Hereinafter, image display examples according to the sixth embodiment will be described with reference to the drawings. FIG. 27 to FIG. 31 are views showing the image display examples according to the sixth embodiment.

First, utilization of the screen 700 will be described with reference to FIG. 27. In FIG. 27, a voltage is applied to a region 710A via an electrode 720A, whereas no voltage is applied to a region 710B via an electrode 720B. That is, the region 710A is transparent, whereas an image is displayed in the region 710B.

As shown in FIG. 27, an object provided on the rear side of the region 710A can be seen via the region 710A from a user taking a position on the front side of the screen 700. On the other hand, an image displayed on the region 710B can be seen from the user taking a position on the front side of the screen 700.

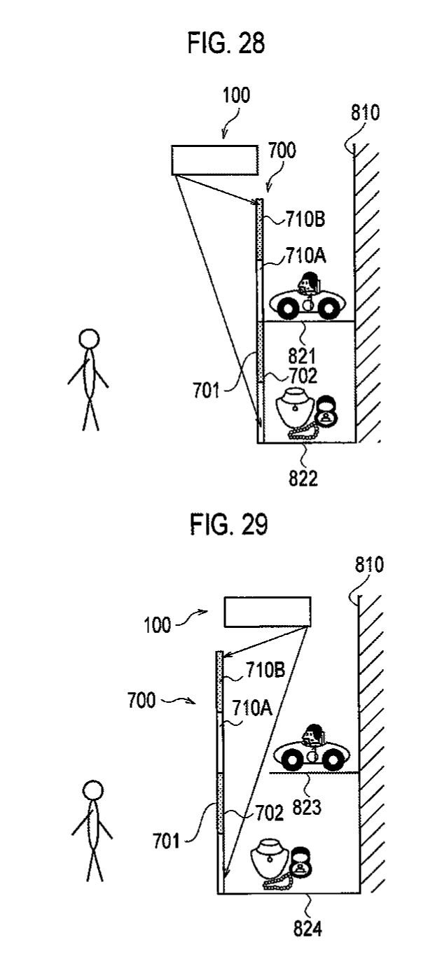

Second, a case in which the projection display apparatus 100 is provided on a ceiling and the screen 700 is disposed in substantially parallel to a wall surface 810 will be described with reference to FIG. 28 to FIG. 30. Racks for placing objects (rack 821 and rack 282) are provided between the wall surface 810 and the screen 700. The screen 700 has a front plane 701 provided on the user's side and a rear plane 702 provided on the side of the wall surface 810.

As shown in FIG. 28, in a case where the projection display apparatus 100 is provided on the user's side rather than on the side of the screen 700, the image light emitted from the projection display apparatus 100 is projected on the front plane 701 of the screen 700. In such a case, the image light emitted from the projection display apparatus 100 is never interrupted by the rack 821 or the object placed on the rack 821. Therefore, the depth of the rack 821 can be reduced.

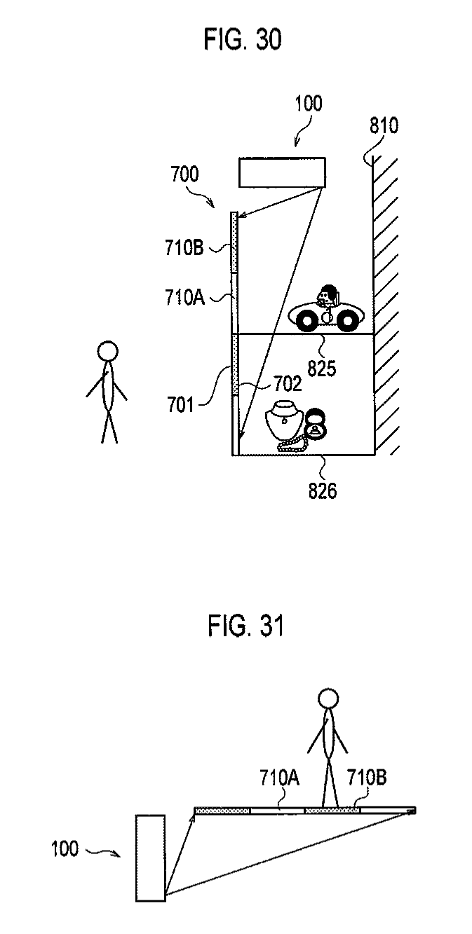

As shown in FIG. 29 and FIG. 30, in a case where the projection display apparatus 100 is provided on the side of the wall surface 810 rather than on the side of the screen 700, the image light emitted from the projection display apparatus 100 is projected on the rear plane 702 of the screen 700. In such a case, there is a possibility that the image light emitted from the projection display apparatus 100 is interrupted by the rack 821 or the object placed on the rack 821.

Therefore, as shown in FIG. 29, it is preferable that the rack 821 is disposed remotely from the screen 700 to the side of the wall surface 810. Alternatively, as shown in FIG. 30, it is preferable that the rack 821 is comprised of a transparent member. As shown in FIG. 29 and FIG. 30, it is preferable that the object placed on the rack 821 is disposed remotely from the screen 700 to the side of the wall surface 810 so as to disallow the image light to be interrupted by the object placed on the rack 821.

Third, a case in which the projection display apparatus 100 is embedded beneath a floor and the screen 700 is provided on a floor surface will be described with reference to FIG. 31.

As shown in FIG. 31, the projection display apparatus 100 can be used in an application (for example, amusement) to an extent such that a user feels as if he or she were floating in the air, by displaying an image in a region 710 in which a user takes a position and making the region 710 transparent, which is provided around the region 710 in which a user takes a position.

(Alignment Processing)

Hereinafter, alignment processing according to the sixth embodiment will be described. Specifically, alignment between an image, which is displayed by the projection display apparatus 100, and the region 710, which is provided on the screen 700, will be described.

(1) The projection display apparatus 100 displays a white image, for example.

(2) An edge of the white image displayed by the projection display apparatus 100 is manually aligned with an edge of the screen 700.

(3) Among a plurality of regions 710 provided on the screen 700, any one region 710 is controlled in a dispersive state, and the remaining regions 710 are controlled in a transparent state.

(4) The region 710 in the dispersive state is picked up by means of an image pickup device provided in the projection display apparatus 100.

(5) The position (coordinate) of the region 710 in the diffusive state is specified by way of image picked up by means of the image pickup device.

(6) The positions (coordinates) of all, of the regions 710 are specified by performing the processes (3) to (5) as to all of the regions 710 provided on the screen 700.

In this manner, the positions (coordinates) of all of the regions 710 are specified by means of the projection display apparatus 100, so that the projection display apparatus 100 can project the image light to be projected on the region 710 (region 710B), on the region 710 (region 710B) on which an image is to be displayed. That is, the projection display apparatus 100 can display an appropriate image on the region 710 (region 710B).

(Function(s) and Advantageous Effect(s))

In the sixth embodiment, the screen 700 is comprised of the plurality of regions 710. The screen 700 is configured to switch whether to diffuse image light or transmit image light in a respective one of the regions 710. Therefore, it is possible to selectively use the region 710A (transparent state) for showing an object provided on the rear-plane side of the region 710 and the region 7108 (diffusive state) for showing an image displayed on the region 710. In this manner, application and usage of the projection display apparatus 100 expand.

### Other Embodiments

As described above, the details of the present invention have been described by using the embodiments of the present invention. However, it should not be understood that the description and drawings which constitute part of this disclosure limit the present invention. From this disclosure, various alternative embodiments, examples, and operation techniques will be easily found by those skilled in the art.

Although not set forth in the foregoing embodiments in particular, the protection cover 400 may have an opening communicating from the reflection mirror 320 to the side of the projection plane 210. The transmissive region 410 may be such an opening.

Although not set forth in the foregoing embodiments in particular, at least part of the protection cover 400 may be comprised of a light-transmissive member such as a transparent resin or a glass. The transmissive region 410 may be comprised of such a light-transmissive member.

Although not set forth in the foregoing embodiments in particular, the reflection mirror 320 focuses the image light emitted from the image light generating unit 200, between the reflection mirror 320 and the projection plane 210. It is preferable that the transmissive region 410 is provided in proximity to a position at which image light is focused by means of the reflection mirror 320.

Although the foregoing embodiments illustrated a case in which a non-spherical mirror is employed as the reflection mirror 320, the reflection mirror 320 is not limitative thereto. For example, a free curved-face mirror may be employed as the reflection mirror 320. A spherical mirror may be employed as the reflection mirror 320 as long as contrivance is made as to aberration or resolution.

While the foregoing embodiments illustrated a case (triple-plate system) in which a plurality of display elements 40 are employed as constituent elements of the image light generating unit 200, the constituent elements of the image light generating unit 200 are not limitative thereto. A single display element 40 may be employed as a constituent element of the image light generating unit 200 (single-plate system).

According to each of the embodiments, as described above, a distance between a projection display apparatus and a projection plane is shortened by providing the reflection mirror 320. Therefore, image light can be restrained from being interrupted by a foreign object such as a person standing between the projection display apparatus and the projection plane. In addition, in a case where a laser diode (LD) is employed as a light source 10, a possibility that a person is irradiated with laser beams can be reduced.

In the fifth embodiment, a respective one of the first screen 510 and the second screen 520 is configured to transmit image light or diffuse image light in accordance with a voltage to be applied. However, the embodiment is not limitative thereto. For example, the following cases are considered.

(1) In a case in which a transparent state is not required, either one of the first screen 510 and the second screen 520 may be a diffusion film configured to diffuse image light irrespective of a voltage to be applied. In such a case, a state of the screen 500 can be switched between a highly directive state and a lowly directly state.

(2) In a case in which a highly directive state is not required, where a desired degree of diffusion is not obtained, two screens (first screen 510 and second screen 20) may be employed. In such a case, a state of the screen 500 can be switched between a highly directive state and a lowly directly state.

### INDUSTRIAL APPLICABILITY

According to the present invention, there can be provided a projection display apparatus which is capable of readily switching display/non-display of an image, with the aim of shortening a distance between the projection display apparatus and a projection plane. The projection display apparatus can be employed in signage, amusement, catering establishment, multistory building or the like. A menu can be displayed on a screen by disposing the screen on a desk of catering establishment, for example. A screen is disposed on a floor surface of a higher floor of multistory building, whereby image display (diffusive state) and image non-display (transparent state) are switched from each other, enabling provision of a user-startling effect.

1. A projection display apparatus, comprising:
an image light generating unit configured to generate image light; and
a projection optical unit configured to project the image light on a projection plane, wherein
the projection optical unit has a reflection mirror configured to reflect the image light emitted from the image light generating unit;
the projection display apparatus further comprising a screen provided on the projection plane; and
the screen is switchably configured as to whether to diffuse the image light reflected by the reflection mirror or to transmit the image light reflected by the reflection mirror.

2. The projection display apparatus set forth in claim 1, wherein:
the screen comprised of a dispersive liquid crystal;
the dispersive liquid crystal adjusts a diffusion ratio of the image light reflected by the reflection mirror, in accordance with a voltage applied to the dispersive liquid crystal.

3. The projection display apparatus set forth in claim 1, wherein:
the screen has an image forming region in which an image is comprised of the image light, and a non-image forming region in which an image is not comprised of the image light;
the screen is configured to be slidable on the projection plane; and
the non-image forming region is comprised of a light-transmissive member and is adjacent to the image forming region in a sliding direction of the screen.

4. The projection display apparatus set forth in claim 1, further comprising a protection cover provided on an optical path of the image light reflected by the reflection mirror, wherein:
the protection cover has a transmissive region for transmitting the image light; the reflection mirror focuses the image light emitted from the image light generating unit, between the reflection mirror and the projection plane; and
the transmissive region is disposed in proximity to a position at which the image light is focused by the reflection mirror.

5. The projection display apparatus set forth in claim 4, wherein:
the protection cover has an opening communicating from a side of the reflection mirror to a side of the projection plane; and
the transmissive region is the opening.

6. The projection display apparatus set forth in claim 4, wherein:
at least part of the protection cover is comprised of a light-transmissive member; and
the transmissive region is comprised of the light-transmissive member.

7. The projection display apparatus set forth in claim 1, wherein:
the screen includes a first screen and a second screen; and
a respective one of the first screen and the second screen is switchably configured as to whether to diffuse the image light reflected by the reflection mirror or to transmit the image light reflected by the reflection mirror.

8. The projection display apparatus set forth in claim 1, wherein:
the screen is comprised of a plurality of regions; and
the screen is switchably configured, in a respective one of the plurality of regions as to whether to diffuse the image light reflected by the reflection mirror or to transmit the image light reflected by the reflection mirror.
